(19) United States
(12) Patent Application Publication
(10) Pub. No.: US 2010/0023849 A1
(43) Pub. Date: Jan. 28, 2010

(54) Creating and Providing Online Presentations

(76) Inventors: Maher Hakim, San Francisco, CA (US); Karimulla Shaikh, Cupertino, CA (US); Emil Nicolae Tamas, Alba Iulia (RO)

Correspondence Address: NORTH WEBER & BAUGH LLP, 2479 E. BAYSHORE ROAD, SUITE 707, PALO ALTO, CA, 94303, US

(21) Appl. No.: 12/177,775

(22) Filed: Jul. 22, 2008

(51) Int. Cl. G06F 17/00; G06F 3/048; G06F 15/16

(52) U.S. Cl. 715/202; 715/730; 709/203

(57) ABSTRACT

Embodiments of the present invention enable building, publishing, and viewing an online presentation. A presenter may create an online presentation on the presenter's local client and then publish the created presentation for access by viewers. In embodiments, a presentation may be represented within a presentation structure as a sequenced set of chapters. A presenter may associate multi-media content with each chapter, and may review and edit the associated multi-media content. The associated multi-media content may be stored at an accessible location, and references to the content may be included in the presentation structure. A viewer may access an online presentation from an online data source by downloading a presentation structure. A presentation player on the viewer's local client may interpret the presentation structure in order to render the associated multi-media content. The multi-media content may be downloaded from a remote storage location specified by the reference within the presentation structure.

### BACKGROUND

A. Technical Field

The present invention pertains generally to data processing, and relates more particularly to creating and providing online presentations.

B. Background of the Invention

Computer networks enable the transfer of data and information from one computer to another. The availability of the internet, a worldwide distribution complex of publically accessible computer networks, has accelerated development of a variety of computing systems and applications that exploit using computers linked via computer networks for rapid and efficient information exchange.

A person at one computer can interact with another person at a second computer by exchanging information over a network that connects the computers. Information exchange may be indirect, such as one person publishing content which can be accessed by a public audience. For example, a person can publish a blog using an online blogging service, a slideshow of digital photographs using an online photo web service, and a digital video clip using an online video streaming service.

Applications also may facilitate direct online exchange of information. One example of such an application is a web conferencing application, in which a group of participants, each at his/her own computer, shares information via a computer network. Each participant may download a copy of a presentation to their own computer and view it together with the other participants in the group, or participants may use a computer network for sending instant messages and communications to one another. Examples of web conferences are online meetings and webinars.

An online presentation, in which a presenter provides information to an audience of viewers, may be published for indirect access and it also may be directly accessed via a web conferencing application. As a web conference, an online presentation may be presented in a primarily one-way webcast, or it may include audience participation such as in a webinar or online classroom. An online presentation enables a presenter to share information with viewers by providing a narration along with supporting multi-media content such as images, animation, and videos.

Typically, an application supporting online presentations is provided as a web service. The application is resident on a host computer platform, and presenters and viewers establish connections with each other via the application executing on the host computer platform. The application may store published content on the host computer platform, and that content is downloaded to participants over the established connections to the host computer. The application may stream multi-media content to a browser running on each participant's computer via a network connection between the host computer and the participant's computer. Applications may support voice communication among participants via a channel (such as VoIP or the telephone) between the host computer and the participants' computers that is separate from the channel used for streaming multi-media content because network bandwidth is limited. It is difficult to achieve seamless integration of online presentation content when it is being delivered across multiple channels of different types.

As the reliance by individuals and businesses on the exchange of information via computing networks continues to grow, it becomes increasingly important to provide computing systems and applications that enable transfer of sets of integrated complex data via computer networks without increasing requirements for additional network bandwidth. It also becomes increasingly important to provide services for rapid creation, publishing, and deployment of information to online audiences.

### SUMMARY OF THE INVENTION

Embodiments of the present invention enable building, publishing, and viewing an online presentation. A presenter may create an online presentation on the presenter's local client and then publish the created presentation for access by viewers. In embodiments, a presentation may be represented within a presentation structure as a sequenced set of chapters. A presenter may associate multi-media content with each chapter, and may review and edit the associated multi-media content. The associated multi-media content may be stored at an accessible location, and references to the content may be included in the presentation structure. A viewer may access an online presentation from an online data source by downloading a presentation structure. A presentation player on the viewer's local client may interpret the presentation structure in order to render the multi-media content associated with each chapter. The multi-media content may be downloaded from a remote storage location specified by the reference within the presentation structure. Content may be pre-fetched and cached on the viewer's client to optimize performance of the presentation player.

In embodiments, a method for generating an online presentation may comprise designating a first set of multi-media content to be inserted in a first chapter within a plurality of chapters comprising the online presentation; converting the first set of multi-media content to a second set of multi-media content that is in a common data format; associating a first multi-media content with a second multi-media content, both being within the second set of multi-media content, within the first chapter such that an execution of the second multi-media content is temporally related to the execution of the first multi-media content; defining a temporal position of the first chapter within the plurality of chapters; creating a presentation structure that defines a relationship of the first chapter within the plurality of chapters; and storing the presentation structure in a second repository. In embodiments, the presentation structure may be an XML document.

In embodiments, the first multi-media content and the second multi-media content may be synchronized by associating them with a set of time points within the presentation structure. In embodiments, the common data format may be a Flash-based format. In embodiments, the first multi-media content may be extracted from a third party data source. In embodiments, the second multi-media content may be created by a presenter. In embodiments, the second multi-media content may be a narration. In embodiments, the second multi-media content may be an annotation.

In embodiments, a method for viewing an online presentation may comprise identifying a location of a presentation structure defining temporal relationships between a plurality of chapters within the online presentation at an online data source; downloading the presentation structure and the plurality of chapters from the online data source to a client computer; and executing a presentation player on the client computer, the presentation player interpreting the presentation structure by rendering the plurality of chapters within the online presentation according to a rendering sequence of the plurality of chapters being defined by the presentation structure. In embodiments, the method may further comprise downloading the presentation player to the client computer from the online data source. In embodiments, the rendering sequence may be designated by a set of time points within the presentation structure.

In embodiments, a first chapter within the plurality of chapters may comprise a set of multi-media content references associated with a set of storage locations of a set of multi-media content, and rendering a first multi-media content within the set of multi-media content may comprise rendering a first multi-media content by downloading the first multi-media content from a second repository and rendering the first multi media content by the presentation player if a reference within the set of multi-media content references that designates a second storage location within a second repository is associated with the first multi-media content. In embodiments, the first multi-media content may be pre-fetched and the second storage location may be within a local cache.

In embodiments, pre-fetching the first multi-media content may comprise identifying a reference within the set of multi-media content references before the first chapter is rendered; and if the reference designates a third storage location within a third repository that is located at a remote data source, the first multi-media content is pre-fetched by downloading the first multi-media content from the third repository and storing the first multi-media content at the second storage location within the local cache.

In embodiments, the client may be an internet viewer client having an internet network connection to the online data source. In embodiments, the client may be an intranet viewer client having an intranet network connection to the online data source. In embodiments, the client may be a community viewer client having a network connection to the online data source and downloading the presentation structure is in response to the community viewer client being granted access to the network connection by the online data source.

In embodiments, the online presentation may be an instructional course. In embodiments, the client may be a student viewer client having a network connection to the online data source and downloading the presentation is in response to the student viewer client being granted access to the network connection by the online data source. In embodiments, the instructional course may be a live instructional course that may further comprise downloading the presentation structure to a presenter viewer client having a first network connection to the online data source and a second network connection to the student viewer client. In embodiments, a first presentation player on the presenter viewer client may interact with a second presentation player on the student viewer client over the second network connection.

In embodiments, a system for publishing an online presentation may comprise a client that provides a toolset that temporally relates a first set of multi-media content and a second set of multi-media content in a first chapter within a plurality of chapters that is represented in a presentation structure; a resource management server that manages the first and second sets of multi-media content within the first chapter; a resource server that comprises a plurality of repositories; and an application server that manages access to the presentation structure and the first and second sets of multi-media content.

In embodiments, a system for viewing an online presentation may comprise a client that provides a presentation player that interprets a presentation structure; an application server that manages access to an online data source; and a content deliver server that provides a set of multi-media content data associated with the online presentation to the client.

Some features and advantages of the invention have been generally described in this summary section; however, additional features, advantages, and embodiments are presented herein or will be apparent to one of ordinary skill in the art in view of the drawings, specification, and claims hereof. Accordingly, it should be understood that the scope of the invention shall not be limited by the particular embodiments disclosed in this summary section.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 illustrates exemplary deployment scenarios for an online presentation according to various embodiments of the invention

FIG. 2A illustrates an exemplary scenario for creating and publishing an online presentation according to various embodiments of the invention.

FIG. 2B illustrates an exemplary scenario for accessing a created online presentation according to various embodiments of the invention.

FIG. 3 depicts a block diagram of a system for creating and providing an online presentation according to various embodiments of the invention.

FIG. 4 depicts a block diagram of a client component within a system for creating and providing an online presentation according to various embodiments of the invention.

FIG. 5 depicts a block diagram of a presentation builder component within a system for creating and providing an online presentation according to various embodiments of the invention.

FIG. 6 depicts a block diagram of a presentation client component within a system for creating and providing an online presentation according to various embodiments of the invention.

FIG. 7 depicts a method for creating an online presentation according to various embodiments of the invention.

FIG. 8 depicts a method for viewing a created online presentation according to various embodiments of the invention.

FIG. 9 depicts a block diagram of a computing system.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be performed in a variety of mediums, including software, hardware, or firmware, or a combination thereof. Accordingly, the flow charts described below are illustrative of specific embodiments of the invention and are meant to avoid obscuring the invention.

Components, or modules, shown in block diagrams are illustrative of exemplary embodiments of the invention and are meant to avoid obscuring the invention. It shall also be understood that throughout this discussion that components may be described as separate functional units, which may comprise sub-units, but those skilled in the art will recognize that the various components, or portions thereof, may be divided into separate components or may be integrated together, including integrated within a single system or component.

Furthermore, connections between components within the figures are not intended to be limited to direct connections. Rather, data between these components may be modified, re-formatted, or otherwise changed by intermediary components. Also, additional or fewer connections may be used. It shall also be noted that the terms “coupled” or “communicatively coupled” shall be understood to include direct connections, indirect connections through one or more intermediary devices, and wireless connections.

Reference in the specification to “one embodiment,” “preferred embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

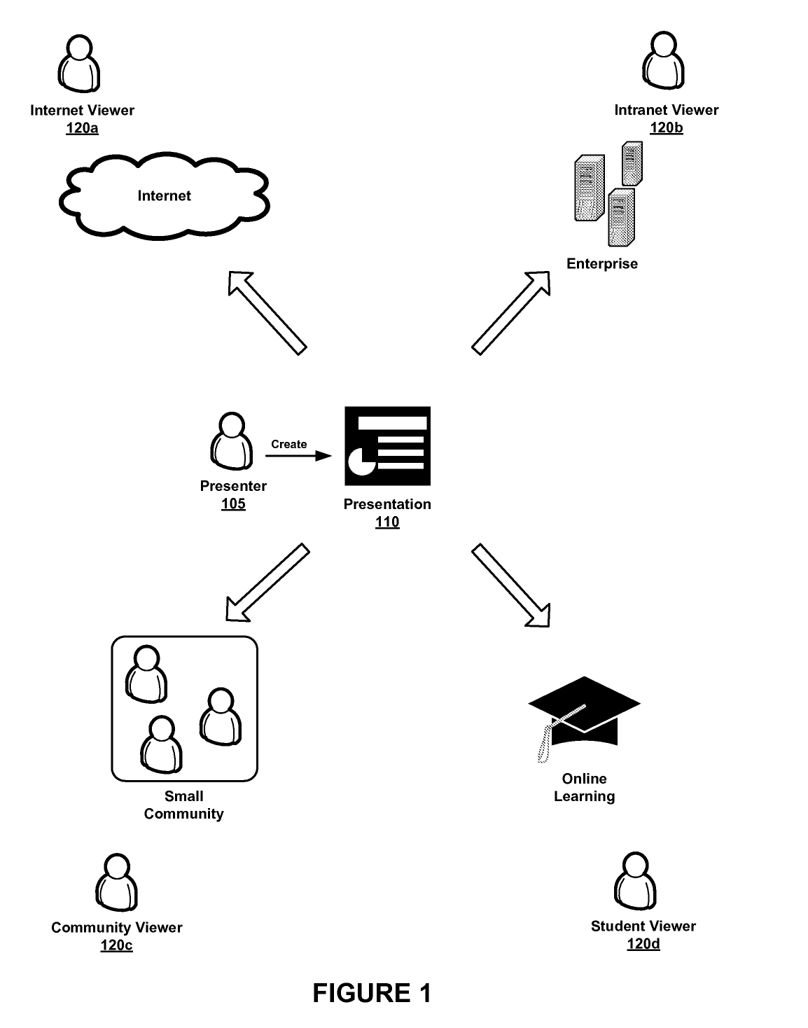

Consider, by way of illustration and not limitation, the exemplary deployment scenarios that are depicted in FIG. 1 for providing an online presentation 110 that has been created by a presenter 105. Using various embodiments of the invention, the presentation 110 may be created locally on the presenter's computer and then may be published by being uploaded to a host computer and stored at a location accessible to viewers. The deployment scenario for the published presentation may be determined by the available network connection between the host computer and the viewer's computer.

In one type of deployment scenario, a published presentation may be distributed to a viewer 120a with a computer having an internet connection to a host computer on which the presentation is published. For example, a narrated personal photo slideshow presentation 110 created by a presenter 105 may be distributed to viewers via the internet by providing a link to the published slideshow's location on a host computer. The link may be sent to a viewer 120a in an email, or the viewer 120a may access the link directly from visiting an internet website hosting a published blog or a social network service. Accessing the link will enable the viewer 120a to retrieve the published slideshow via the internet and view it on the viewer's computer.

In another type of deployment scenario, a published presentation may be distributed to a viewer 120b having a computer with an intranet connection (for example, behind an enterprise firewall) to a host computer such as a corporate server. For example, a presentation 110 of an internal company communication may be created by a presenter employee 105 and published on a corporate server. A link to the location of the company presentation on the corporate server may be sent to a viewer employee 120b through an email, or the link may be accessed directly by the viewer employee 120b through visiting an internal corporate website. Accessing the link will enable the viewer employee 120b to retrieve the company communication via the intranet and view it on the viewer employee's computer.

In a third type of deployment scenario, a published presentation for use of a small community may be distributed to members of the community or to an audience with an interest in the community. For example, an organized small community may offer specialty presentations to a community viewer 120c or viewers. A community member presenter 105 may create a specialty presentation 110 and publish it to a community-maintained host computer with a network connection. Access to the network connection is specified by policies of the community. A community viewer 120c may be granted access to the host computer in exchange for a donation to the community, and then the community viewer 120c may retrieve the specialty presentation from the community-maintained host computer for viewing on the community viewer's computer.

In a fourth type of deployment scenario, access to an instructional course designed for online learning may be provided to a student viewer 120d. For example, an instructional course may be published on a commercial website hosted by an educational institution, a business, or another type of organization. An instructor (i.e. domain expert) presenter 105 creates a class presentation 110 and publishes it on the commercial website. A student viewer 120d may be granted access to the commercial website in exchange for a fee or as a public service, and the student viewer 120d may retrieve the class presentation from the commercial website for viewing on the student viewer's computer. Using various embodiments of the invention, a “live” class session may be achieved in which the student viewer 120d views the presentation and also interacts with the instructor presenter 105 via a network connection between the instructor presenter's computer and the student viewer's computer.

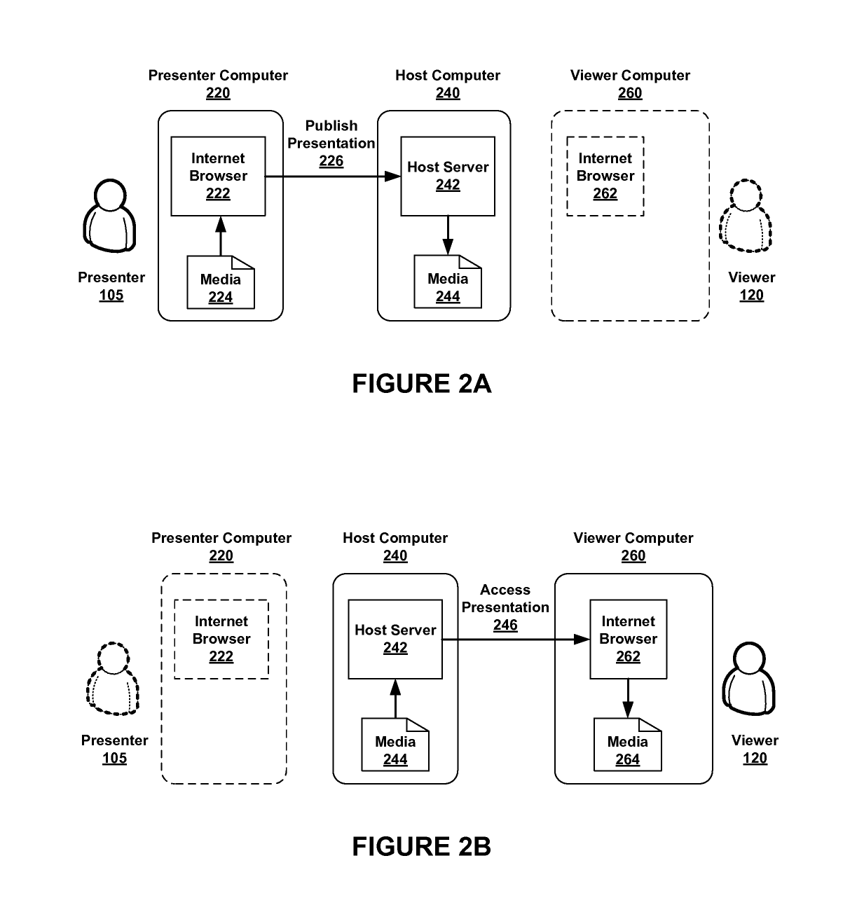

FIGS. 2A and 2B illustrate applications of embodiments of the present invention in exemplary scenarios for creating and providing an online presentation using a host computer platform 240 accessed via a network connection. Those skilled in the art will recognize that a variety of types of network connections exist (e.g. internet and intranet connections), and that a host computer 240 platform may be implemented on a single computer or a network of computers. Both the choice of network connection and the choice of host computer platform implementation are not critical to the invention.

In FIG. 2A, a presenter 105 creates a presentation by using tools available on the presenter's computer 220 through an internet browser 222. In alternate embodiments, various tools may be available as desktop applications that do not require a browser. The presentation being created may include multi-media content 224 chosen by the presenter. The presentation, including the multi-media content, is published 226 by being uploaded via a network connection to the host computer 240, where it is stored on a server 242. A detailed discussion of certain embodiments of presentation creation tools is provided later in the application.

In FIG. 2B, a viewer 120 may access 246 a published presentation by downloading the presentation and a presentation player over the network connection from the host computer 240. The presentation player is accessed locally on the viewer's computer 260 through an internet browser 262. In alternate embodiments, the presentation player may be available as a desktop application that does not require a browser. The presentation player renders the presentation, including the multi-media content, locally on the viewer's computer 260.

In these exemplary scenarios, presentation creation as illustrated in FIG. 2A does not involve the viewer 120 or viewer computer 260, while presentation access as illustrated in FIG. 2B does not involve the presenter 105 or the presenter computer 220. In scenarios applying alternate embodiments of the invention, a presentation may be designed to be an interactive presentation in which both the presenter 105 and the viewer 120 participate. During an interactive presentation, the presenter 105 using the presenter's computer 220 and the viewer 120 using the viewer's computer 260 may simultaneously access an instance of a published presentation and its media using a network connection from the host 240. In various embodiments, the presenter 105 and the viewer 120 may interact with each other and with the presentation directly via a network connection between the presenter's computer 220 and the viewer's computer 260.

A. System Implementations

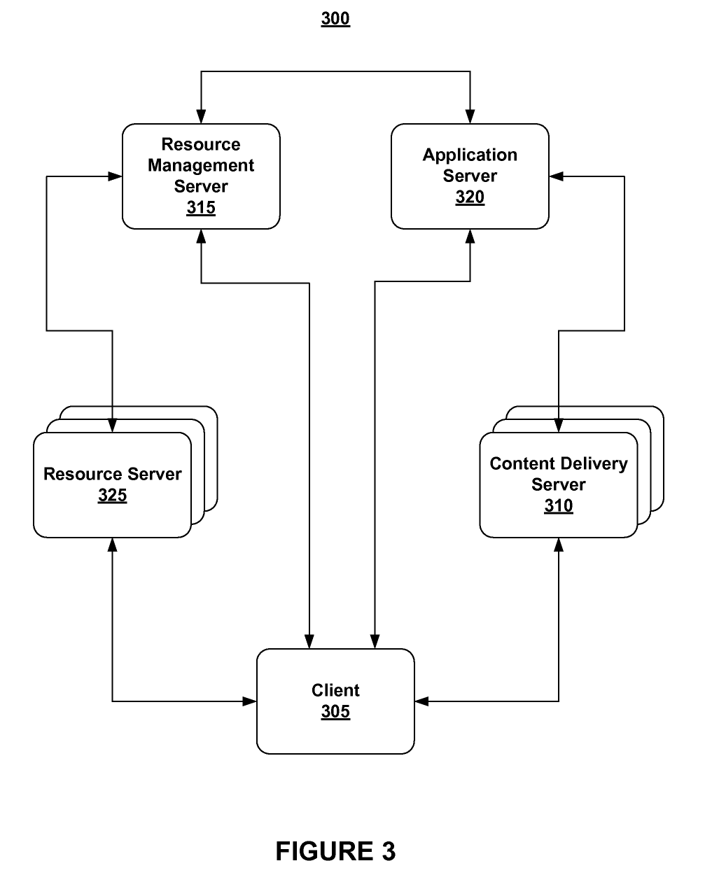

FIG. 3 depicts a block diagram of a system 300 for creating and providing an online presentation according to various embodiments of the invention. The components of system 300 may be distributed across a client/server application platform, although those skilled in the art will recognize that many types of application platform exist and that the choice of application platform is not critical to the invention.

In embodiments, system 300 may be implemented using the Adobe Flex application framework (“Flex”). Flex applications deliver content to users via a “Flash player” client application. Flash is a set of multi-media technologies and is widely used in “rich internet applications” (RIA) to provide animation and other graphics support, such as video integration, to applications delivered via the web. Flash players are applications that render Flash content, and they are found in many types of web clients such as browsers and mobile phones. Execution of a Flex implementation of system 300 may include a Flash player on a client 305 component that communicates with the other components (310, 315, 320, and 325) via the web services interfaces available within a Flex application framework. Those skilled in the art will recognize that other web application frameworks exist, including those not based on Flex, and that embodiments of the invention may be implemented using these other web application frameworks.

In embodiments of system 300, a presenter 105 and/or a viewer 120 may interact with the system 300 via a user interface on a client 305 component. In various embodiments, the client 305 component is implemented on a local computer (i.e. the presenter's computer 220 and the viewer's computer 260). In various embodiments, a content delivery server 310, a resource management server 315, an application server 320, and a resource server 325 may be implemented on a host computer platform 240.

In various embodiments of the invention, a resource management server 315 manages the multi-media content associated with a created presentation. Examples of multi-media content include presentation slides, digital photographs, and video clips. Content may be pre-existing (e.g. published web content, files stored on the presenter's computer 220, and content already created for previous presentations and stored on the host computer platform 240), and content also may be dynamically created by the presenter 105 (e.g. narration, visual annotation, and a video clip captured from a webcam). In various embodiments, dynamically created content may be managed by a content delivery server 310 while pre-existing content may be managed by a resource management server 315.

In embodiments, a resource management server 315 may process client requests for access and processing of multi-media content. A resource management server 315 may perform content conversion of multi-media content associated with a presentation by using a conversion engine that converts the content into a common format (for example, the SWF format used by Flash). Embodiments of a conversion engine are discussed in more detail in the following section. Converted content as well as content in its original format may be stored in repositories on one or more resource servers 325. In various embodiments of system 300, a resource management server 315 may be coupled to a resource server 325 that hosts one or more repositories. The resource management server 315 may handle requests from other components for access to the content stored in a repository on the resource server 325. In embodiments, content access requests may be communicated via interfaces between a resource management server 315 and a client 305, and between a resource management server 315 and an application server 320.

In embodiments, a content delivery server 310 enables efficient transmission of stored content via a network connection to a client 305. Following is an exemplary implementation of a content delivery server 310 for illustration purposes; those skilled in the art will recognize that the implementation choices for a content delivery server are not critical to the invention. A content delivery server 310 may receive requests to provide specified content to a client 305 at a specified network address. In embodiments, these requests may be communicated via shared interfaces with a resource management server 315 or with an application server 320. In embodiments, the content may be stored on an origin server within the content delivery server 310 until the content can be deployed to an edge origin network that supports an array of edge servers, each of which is dedicated to support network connections within a specific geographic region (e.g. Asia Pacific region, Americas region, and Europe region). The content is deployed from the origin server to an edge server supporting network connections within a geographic region that is closest to the network address specified in the request, and then the content is deployed from the edge server to the client 305 at the specified network address. In this scenario, content delivery performance is optimized because the length of the network connection between the client 305 and the system 300 is minimized.

A resource server 325 may support requests to store uploaded content in a content repository. In embodiments, these content upload requests may be communicated via shared interfaces with a resource management server 315, with an application server 320, or with a client 305. A resource server 325 also may support requests to download content stored in a content repository. In embodiments, these content download requests may be communicated via shared interfaces with an application server 320, or with a client 305. To improve content access performance and reliability, embodiments of system 300 may include an interconnected array of multiple resource servers 325. The stored content of the system 300 may be replicated and distributed across the content repositories on the multiple resource servers 325, allowing the system to perform load balancing of content access requests in terms of the availability of each resource server 325 within the array to service a request. In embodiments, an interconnected array of multiple resource servers 325 may be configured to optimally service requests that originate from various geographic regions according to an exemplary scenario similar to the scenario described for content delivery servers 310.

In embodiments, an application server 320 processes and routes requests for service between components of system 300. In various embodiments, an application server 320 may share interfaces with a resource management server 315, a resource server 325, a content delivery server 310, and a client 305. In embodiments, an application server 320 may host a name service. Exemplary functions that may be performed by an application server 320 may include, but are not limited to, messaging, scheduling, payment processing, member management (supporting subscribed users), and search/browse functionality. In embodiments, an application server 320 may host an instructor directory, a class catalog, ratings/comments from users, and an on-demand content index.

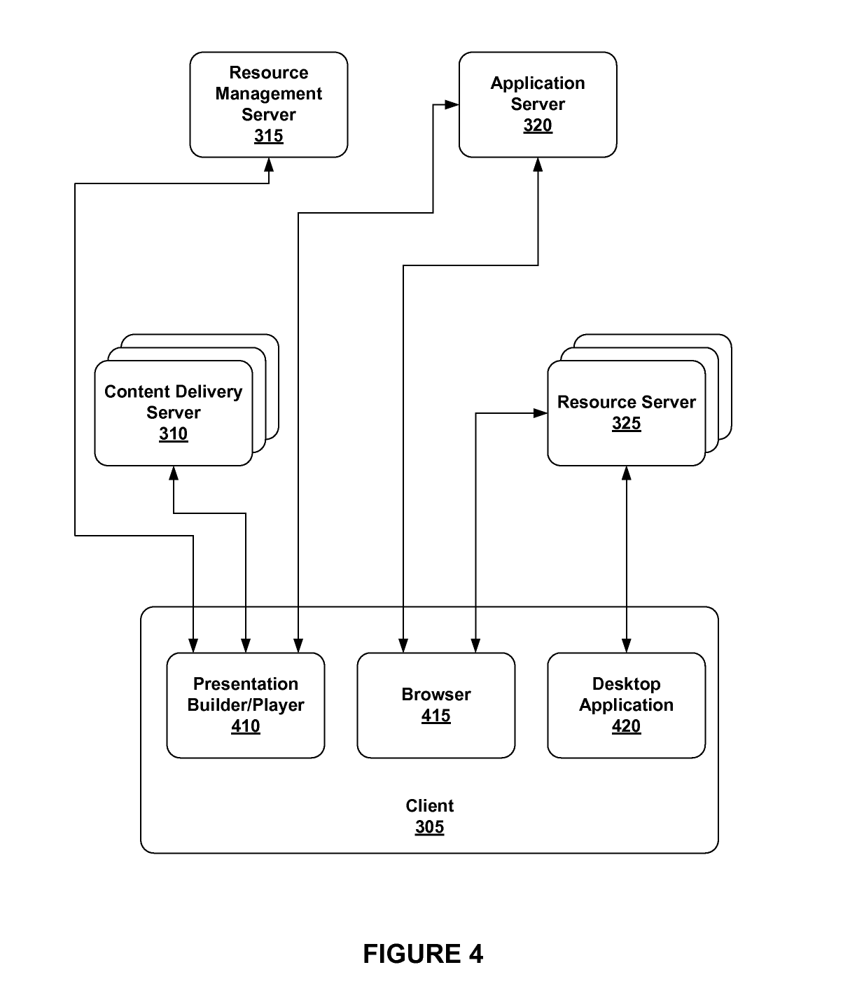

FIG. 4 depicts a block diagram of a client 305 according to various embodiments of the invention. In embodiments, a client 305 may be implemented on a presenter's computer 220 and/or on a viewer's computer 260. A client 305 may present a user interface to a presenter 105 for creation and publishing of a presentation. A client 305 may present a user interface to a viewer 120 for accessing and viewing a presentation. The client 305 comprises a presentation builder/player 410, a browser 415, and a desktop application 420.

In embodiments, a presentation builder/player 410 may include a player that can interpret scripts for rendering multi-media content such as a Flash player. In embodiments, a presentation builder/player 410 may be integrated into a browser 415 or, in alternate embodiments, share an interface with a desktop application 420 within the client 305.

The components comprising a client 305 are discussed in more detail in the exemplary scenarios within the following sections.

1. System for Creating and Publishing an Online Presentation

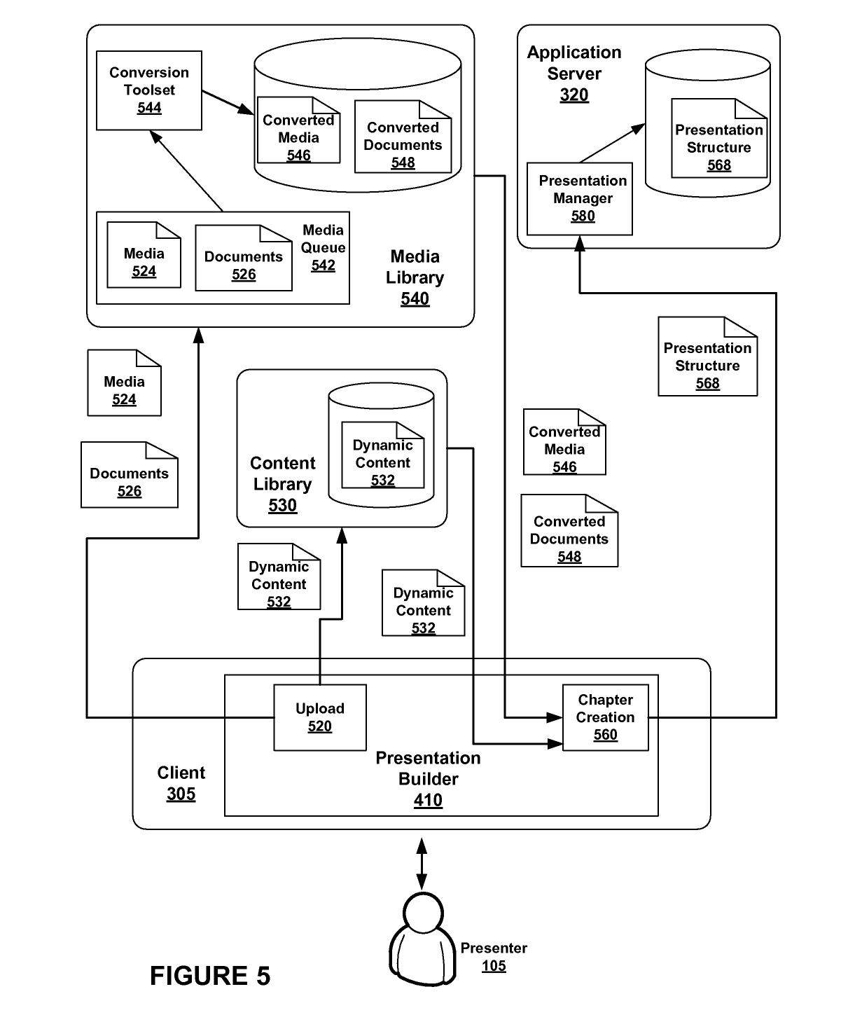

FIG. 5 illustrates an exemplary scenario for creation and publishing of an online presentation according to various embodiments of system 300. A presenter 105 interacts with a presentation builder 410 on the presenter's computer 220. In embodiments of system 300, a presentation is represented as a sequence of chapters, and the task of building a presentation comprises interacting with a presentation builder 410 to build each chapter and assign it to the sequence of chapters. A chapter may include multi-media content that has been selected by a presenter 105 from a variety of sources.

In embodiments, selected content that may include media 524 and documents 526 is uploaded 520 from the presentation builder 410 to a media library 540, which may be implemented in embodiments of a resource management server 315 on the host computer 240. The uploaded content (524 and 526) is converted by a conversion toolset 544 (i.e. conversion engine) into a common format, and the converted content (546 and 548) is both stored in a repository (which may be implemented in embodiments of a resource server 325 on the host computer 240) and downloaded back to the presentation builder 410 on the client 305. In alternate embodiments, the conversion toolset 544 may be implemented in embodiments of a desktop application 420 on the client 305, and the converted content may be either uploaded to the host computer 240 for storage and/or cached on the client 305. In embodiments, the content in its original format (524 and 526) also may be stored in a repository on the host computer 240 and/or cached on the client 305.

In embodiments, selected content may include dynamic content 532 created by the presenter 105 in real time (e.g. narration, visual annotation, and a video clip captured from a webcam). This dynamic content may be uploaded 520 from the presentation builder 410 to a content library 530, which may be implemented in embodiments of a content delivery server 310 on the host computer 240. The dynamic content 532 may be stored in a repository on the host computer 240 and/or cached on the client 305.

The presenter 105 may use the presentation player 410 to preview the rendered converted content (546 and 548) and dynamic content 532, enabling use of the presentation builder 410 for interactive editing and review of the content to be associated with a chapter on the presenter's computer 220 during chapter creation 560. Since the converted content is in a common format, the presenter 105 may use the presentation builder 410 to integrate different kinds of content associated with a chapter.

In embodiments, a presenter 105 may use the presentation builder 410 to sequence and organize a set of created chapters. The structure of the organized set of chapters may be represented in a document (a “presentation structure” 568). In embodiments, the presentation structure 568 is an XML document, although those skilled in the art will recognize that many representational schemes exist and that the choice of representation scheme is not critical to the invention. The representation of a chapter within a presentation structure 568 may contain references to the locations of stored content on the host computer 240. Using a reference to location of a stored content instance in a presentation structure 568 instead of explicitly including a copy of the content instance in each document facilitates management of stored content and also minimizes presentation storage and deployment costs because content is not replicated when a presentation structure 568 is provided to a viewer 120.

A presenter may publish a presentation by uploading its presentation structure 568 to a presentation manager 580 on the host 240, where it is stored in a repository. The presentation manager 580 may be implemented in embodiments of an application server 320 on the host computer 240, and the repository may be implemented in embodiments of an application server 320 on the host computer 240.

2. System for Access and Viewing an Online Presentation

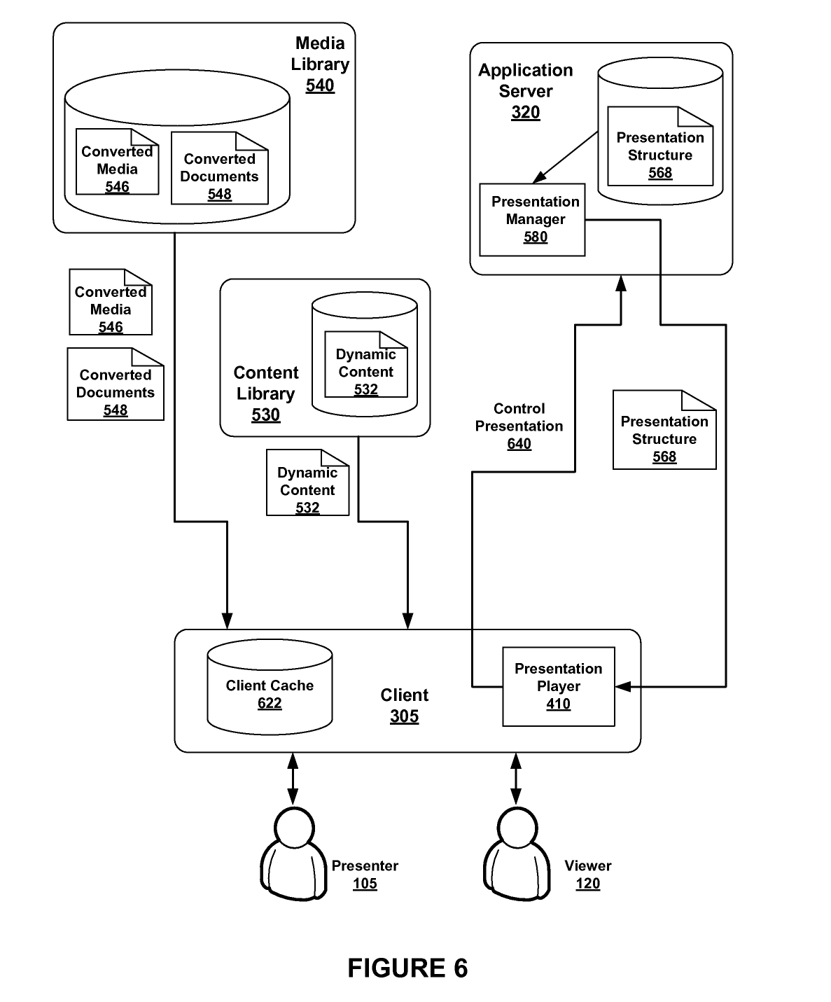

FIG. 6 illustrates an exemplary scenario for accessing and viewing an online presentation according to various embodiments of the invention. As previously discussed, embodiments of the invention enable viewing of a published presentation on a client 305 by a viewer 120, a presenter 105, or both a viewer 120 and a presenter 105 simultaneously.

In embodiments, a published presentation may be accessed by downloading a requested instance of a presentation structure 568 from a presentation manager 580 that is stored on the host computer 240 to a presentation player 410 on a viewer's computer 260. As discussed previously, a presentation structure 568 may include references to content associated with the presentation. In embodiments, this content may include converted media (546 and 548) stored in a repository in a media library 540 on a host computer 240. This content also may include dynamic (“real-time”) content 532 stored in a repository in a content library 530 on a host computer 240.

Downloading of instances of referenced stored content may be implemented in embodiments of a resource management server 315 and/or in embodiments of a content delivery server 310. In embodiments, content stored on trusted sites (for example, corporate resources behind a firewall accessed from within an intranet) also may be referenced from a presentation structure 568 and downloaded to the presentation player 410 directly from the trusted sites.

In embodiments, content associated with upcoming chapters within the chapter sequence in the presentation structure 568 may be “pre-fetched” (downloaded in the background) while the presentation player 410 is rendering a chapter in the presentation structure 568, and then the downloaded content may be cached on the client 622. Caching content on the client may optimize performance of the presentation player because accessing locally cached content for rendering avoids potential network delay associated with downloading content from a remote source.

In various embodiments of system 300, there may be a presenter version of a presentation player 410 on a presenter's computer 220 that may upload presentation control commands 640 to the host computer 240 to affect the presentation structure 568 being downloaded to a viewer version presentation player 410 on a viewer computer 260. In embodiments, the presentation player on the presenter's computer 220 may send commands to the presentation player on the viewer's computer 260 via a direct network connection such as a “peer-to-peer” connection.

In various embodiments, session management for an accessed presentation may be implemented in embodiments of an application server 320 on the host computer 240. Session management may include recording and management of session logs and session state collected by the presentation player 410 on a viewer's computer 260, and uploaded to a presentation manager 580 on a host computer 240.

B. Methods for Creating and Publishing a Presentation

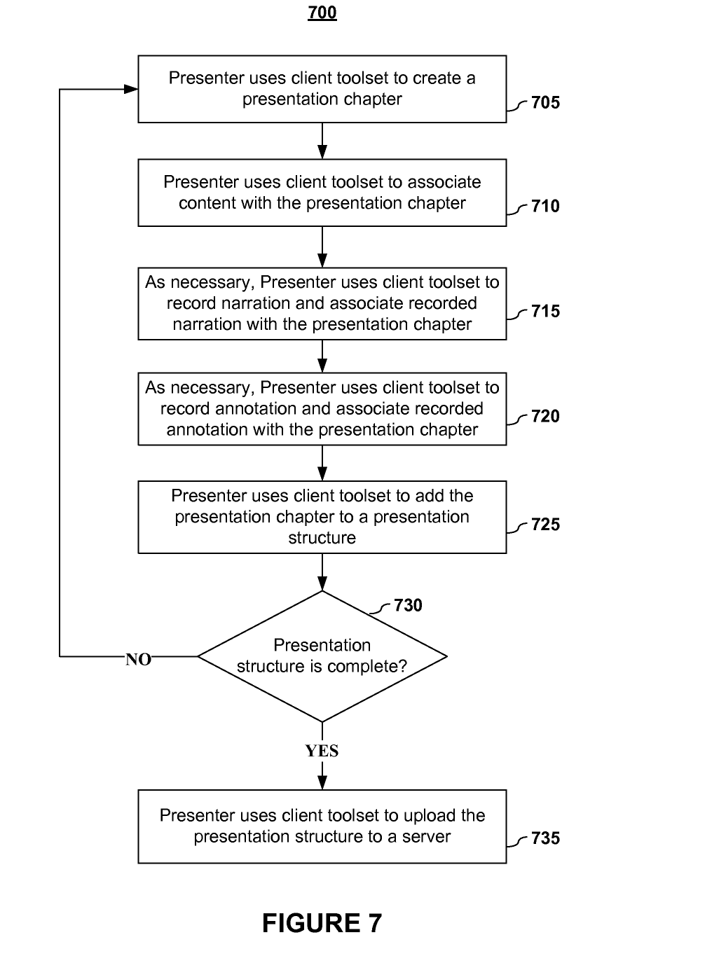

FIG. 7 depicts a method 700, independent of structure, for creating and publishing an online presentation according to various embodiments of the invention. Method 700 may be implemented by embodiments of system 300. An exemplary scenario for creating and publishing a presentation is illustrated in FIG. 2A.

As previously discussed, a presenter 105 may use a “presentation builder toolset” executing on the presenter's computer 220 to create and publish an online presentation. In various embodiments, a presentation is a sequenced set of chapters. A presenter 105 may use the presentation builder toolset to build each chapter, and also may use the presentation builder toolset to organize the chapter sequence. In embodiments, the presentation builder toolset may be implemented as an application that is accessed via a user interface on the presenter's computer 220. In various embodiments, the application may execute within a browser 222.

In embodiments, the toolset is used to create 705 a chapter and then to associate 710 content with the chapter. As previously discussed, content may be multi-media such as documents, digital images, and video clips, and may be selected from multiple sources such as sources published on the internet, digital files stored in file archives, and a repository on the host computer 240 with stored content associated with previously created presentations. Content, such as narration and a video clip created using a webcam, also may be created dynamically by the presenter 105.

In embodiments, content selected by a presenter 105 is converted into a common format (for example, the SWF format used by Flash) that can be rendered by a presentation player. In embodiments, a presenter 105 may use the presentation builder toolset for review and interactive edit of content associated with a chapter being created. The presentation builder toolset may also be used to design the layout of chapter content by, for example, specifying content size, position, and font information if the content includes text.

In embodiments, a presenter 105 may use the presentation builder toolset to record narration and associate 715 the recorded narration with the presentation chapter being created. The presentation builder toolset also may be used to record annotations and associate 720 the recorded annotations with the presentation chapter being created. For example, a presenter may add narration to a slideshow presentation being created. Annotations (e.g. arrows, circles, and handwritten notes) also may be associated with an individual slide within the slideshow presentation so that the annotations may be rendered in synchrony with the slide and any associated narration. In embodiments, the rendering sequence of a chapter may be represented within a presentation structure 568 as a sequence of “time points,” and the rendering of annotations and narrations may be associated with particular time points within the sequence. In embodiments, narration and annotation also may be associated with video content.

The structure of an organized set of chapters may be represented in a document (a “presentation structure” 568). In embodiments, the presentation structure is an XML document, although those skilled in the art will recognize that many representational schemes exist and that the choice of representation scheme is not critical to the invention. The presenter 105 may use the presentation builder toolset to add 725 a created chapter to a presentation structure 568 as well as to organize the sequence of chapters within the presentation structure 568. The presenter 105 may create additional chapters and add them to the presentation structure (repeat steps 705 through 725) until a complete presentation has been created 730.

In embodiments, a presenter may publish a completed presentation by using the presentation builder toolset to upload 735 the completed presentation structure 568 to a host computer 240, where the presentation structure 568 is stored in a repository as previously discussed. In embodiments, a reference to the published presentation may be made available to potential viewers by, for example, displaying a link to the location of the stored presentation structure 568 on a website or by including the link in an email.

C. Methods for Viewing a Published Presentation

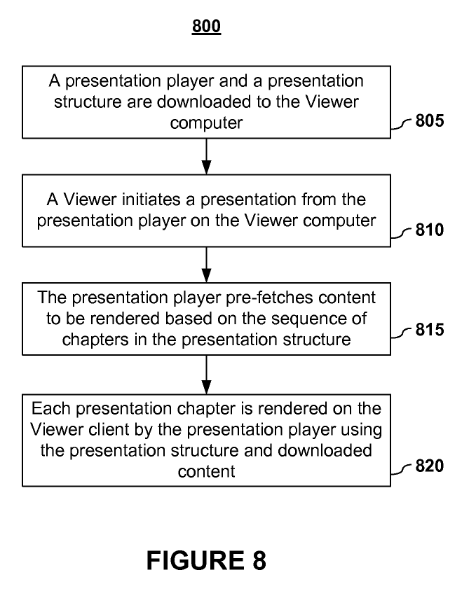

FIG. 8 depicts a method 800, independent of structure, for viewing a published online presentation according to various embodiments of the invention. Method 700 may be implemented by embodiments of system 300. An exemplary scenario for viewing a published online presentation is illustrated in FIG. 2B.

As previously discussed, a viewer 120 may initiate access to a published online presentation by downloading 805 a presentation structure 568 that represents the presentation. In embodiments, the presentation structure 568 is interpreted by a presentation player 410 application to orchestrate the rendering of the presentation content on the viewer's computer 260. In various embodiments, a presentation player 410 also may be downloaded from the host computer 240 to the viewer's computer and may execute as part of a “presentation client” within a browser 262 or, in other embodiments, as a standalone desktop application.

In embodiments, a viewer 120 initiates 810 a presentation by executing the rendering of the presentation structure 568 by the presentation player 410 on the viewer's computer 260. As previously discussed, the presentation structure 568 may be a document, such as an XML document, that contains a representation of a presentation as a sequence of chapters. Within the presentation structure 568, the sequence of chapters may be associated with a sequence of “time points” that control the rendering of each chapter. The representation of a chapter may contain references to associated content. A reference to associated content is resolved by downloading an instance of the referenced content to the viewer's computer 260. The content may be stored in a repository on a host computer 240, or, in various embodiments, the content may be located at a trusted site having a network connection to the viewer's computer 260.

In embodiments, content associated with upcoming chapters in the sequence of chapters may be “pre-fetched” (accessed in the background) 815 to the viewer's computer 260 and cached while the current chapter is being rendered. Caching content on the viewer's computer 260 may optimize performance of the presentation player because rendering locally cached content avoids the potential network delay associated with downloading content from a remote source.

In embodiments, a presentation player 410 may render a presentation by rendering 820 each chapter in the sequence specified in the presentation structure 568. In embodiments, a viewer 120 may use the presentation player 410 to select any chapter for current viewing independent of the specified sequence. In embodiments, the content associated with a chapter is in a standard format that can be rendered by the presentation player 410 (for example, the SWF format used by Flash).

In embodiments, session data collected by the presentation player during a viewing of a presentation may be uploaded to a host computer 240 to be used for session management.

D. Computing System Implementations

It shall be noted that the present invention may be implemented in any instruction-execution/computing device or system capable of processing data, including without limitation, a general-purpose computer and a specific computer, such as one intended for data processing. The present invention may also be implemented into other computing devices and systems. Furthermore, aspects of the present invention may be implemented in a wide variety of ways including software, hardware, firmware, or combinations thereof. For example, the functions to practice various aspects of the present invention may be performed by components that are implemented in a wide variety of ways including discrete logic components, one or more application specific integrated circuits (ASICs), and/or program-controlled processors. It shall be noted that the manner in which these items are implemented is not critical to the present invention.

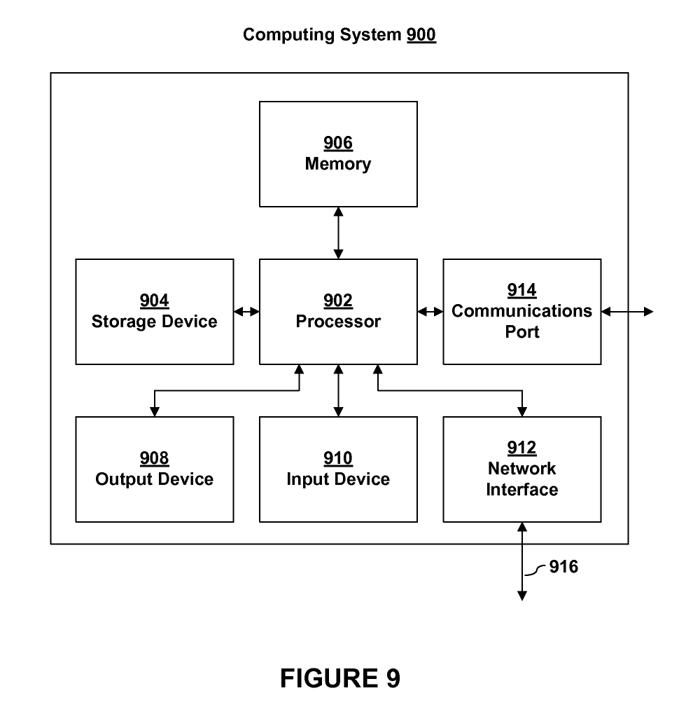

FIG. 9 depicts a functional block diagram of an embodiment of an instruction-execution/computing device 900 that may implement or embody embodiments of the present invention. As illustrated in FIG. 9, a processor 902 executes software instructions and interacts with other system components. In an embodiment, processor 902 may be a general purpose processor such as (by way of example and not limitation) an AMD processor, an INTEL processor, a SUN MICROSYSTEMS processor, or a POWERPC compatible-CPU, or the processor may be an application specific processor or processors. A storage device 904, coupled to processor 902, provides long-term storage of data and software programs. Storage device 904 may be a hard disk drive and/or another device capable of storing data, such as a computer-readable media (e.g., diskettes, tapes, compact disk, DVD, and the like) drive or a solid-state memory device. Storage device 904 may hold programs, instructions, and/or data for use with processor 902. In an embodiment, programs or instructions stored on or loaded from storage device 904 may be loaded into memory 906 and executed by processor 902. In an embodiment, storage device 904 holds programs or instructions for implementing an operating system on processor 902. In one embodiment, possible operating systems include, but are not limited to, UNIX, AIX, LINUX, Microsoft Windows, and the Apple MAC OS. In embodiments, the operating system executes on, and controls the operation of, the computing system 900.

An addressable memory 906, coupled to processor 902, may be used to store data and software instructions to be executed by processor 902. Memory 906 may be, for example, firmware, read only memory (ROM), flash memory, non-volatile random access memory (NVRAM), random access memory (RAM), or any combination thereof. In one embodiment, memory 906 stores a number of software objects, otherwise known as services, utilities, components, or modules. One skilled in the art will also recognize that storage 904 and memory 906 may be the same items and function in both capacities. In an embodiment, one or more of the components of FIGS. 3 and 4 may be modules stored in memory 904, 906 and executed by processor 902.

In an embodiment, computing system 900 provides the ability to communicate with other devices, other networks, or both. Computing system 900 may include one or more network interfaces or adapters 912, 914 to communicatively couple computing system 900 to other networks and devices. For example, computing system 900 may include a network interface 912, a communications port 914, or both, each of which are communicatively coupled to processor 902, and which may be used to couple computing system 900 to other computer systems, networks, and devices.

In an embodiment, computing system 900 may include one or more output devices 908, coupled to processor 902, to facilitate displaying graphics and text. Output devices 908 may include, but are not limited to, a display, LCD screen, CRT monitor, printer, touch screen, or other device for displaying information. Computing system 900 may also include a graphics adapter (not shown) to assist in displaying information or images on output device 908.

One or more input devices 910, coupled to processor 902, may be used to facilitate user input. Input device 910 may include, but are not limited to, a pointing device, such as a mouse, trackball, or touchpad, and may also include a keyboard or keypad to input data or instructions into computing system 900.

In an embodiment, computing system 900 may receive input, whether through communications port 914, network interface 912, stored data in memory 904/906, or through an input device 910, from a scanner, copier, facsimile machine, or other computing device.

One skilled in the art will recognize no computing system is critical to the practice of the present invention. One skilled in the art will also recognize that a number of the elements described above may be physically and/or functionally separated into sub-modules or combined together.

It shall be noted that embodiments of the present invention may further relate to computer products with a computer-readable medium that have computer code thereon for performing various computer-implemented operations. The media and computer code may be those specially designed and constructed for the purposes of the present invention, or they may be of the kind known or available to those having skill in the relevant arts. Examples of computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter.

While the invention is susceptible to various modifications and alternative forms, specific examples thereof have been shown in the drawings and are herein described in detail. It should be understood, however, that the invention is not to be limited to the particular forms disclosed, but to the contrary, the invention is to cover all modifications, equivalents, and alternatives falling within the scope of the appended claims.

What is claimed is:

1. A method for generating an online presentation, the method comprising:
designating a first set of multi-media content to be inserted in a first chapter within the online presentation, the online presentation comprising a plurality of chapters;
converting the first set of multi-media content to a second set of multi-media content, the second set of multi-media content being in a common data format;
storing the second set of multi-media content in a first repository;
associating a first multi-media content with a second multi-media content within the first chapter, the first and second multi-media contents being within the second set of multi-media content, such that an execution of the second multi-media content is temporally related to the execution of the first multi-media content;
defining a temporal position of the first chapter within the plurality of chapters;
creating a presentation structure that defines a relationship of the first chapter within the plurality of chapters; and
storing the presentation structure in a second repository.

2. The method of claim 1 wherein the presentation structure is an XML document.

3. The method of claim 1 wherein the first multi-media content and the second multi-media content are synchronized by associating them with a set of time points within the presentation structure.

4. The method of claim 1 wherein the common data format is a Flash-based format.

5. The method of claim 1 wherein the first multi-media content is extracted from a third party data source.

6. The method of claim 1 wherein the second multi-media content is created by a presenter.

7. The method of claim 6 wherein the second multi-media content is a narration.

8. The method of claim 6 wherein the second multi-media content is an annotation.

9. A computer readable medium having instructions for performing the method of claim 1.

10. A method for viewing an online presentation, the method comprising:
identifying a location of a presentation structure at an online data source, the presentation structure defining temporal relationships between a plurality of chapters within the online presentation;
downloading the presentation structure and the plurality of chapters from the online data source to a client computer; and
executing a presentation player on the client computer, the presentation player interpreting the presentation structure by rendering the plurality of chapters within the online presentation according to a rendering sequence of the plurality of chapters being defined by the presentation structure.

11. The method of claim 10 further comprising downloading the presentation player to the client computer from the online data source.

12. The method of claim 10 wherein the rendering sequence is designated by a set of time points within the presentation structure.

13. The method of claim 10 wherein a first chapter within the plurality of chapters comprises a set of multi-media content references associated with a set of storage locations of a set of multi-media content, and rendering a first multi-media content within the set of multi-media content comprises:
responsive to a reference within the set of multi-media content references being associated with the first multi-media content, the reference designating a second storage location within a second repository, rendering the first multi-media content by:
downloading the first multi-media content from the second repository; and
rendering the first multi-media content by the presentation player.

14. The method of claim 13 wherein the first multi-media content is pre-fetched and the second storage location is within a local cache.

15. The method of claim 14 wherein pre-fetching the first multi-media content comprises:
identifying a reference within the set of multi-media content references within the first chapter before the first chapter is rendered, the reference being associated with the first multi-media content and the reference designating a third storage location within a third repository; and
responsive to the third repository being located at a remote data source, pre-fetching the first multi-media content by:
downloading the first multi-media content from the third repository; and
storing the first multi-media content at the second storage location within the local cache.

16. The method of claim 10 wherein the client is an internet viewer client having an internet network connection to the online data source.

17. The method of claim 10 wherein the client is an intranet viewer client having an intranet network connection to the online data source.

18. The method of claim 10 wherein the client is a community viewer client having a network connection to the online data source.

19. The method of claim 18 wherein the step of downloading the presentation structure is in response to the community viewer client being granted access to the network connection by the online data source.

20. The method of claim 10 wherein the online presentation is an instructional course.

21. The method of claim 20 wherein the client is a student viewer client having a network connection to the online data source.

22. The method of claim 21 wherein the step of downloading the presentation structure is in response to the student viewer client being granted access to the network connection by the online data source.

23. The method of claim 21 wherein the instructional course is a live instructional course further comprising downloading the presentation structure to a presenter viewer client having a first network connection to the online data source and a second network connection to the student viewer client.

24. The method of claim 23 wherein a first presentation player on the presenter viewer client interacts with a second presentation player on the student viewer client over the second network connection.

25. A computer readable medium having instructions for performing the method of claim 10.

26. A system for publishing an online presentation, the system comprising:
a client that provides a toolset that temporally relates a first set of multi-media content and a second set of multi-media content in a first chapter of the online presentation, the toolset creating a plurality of chapters, including the first chapter, that is represented in a presentation structure;
a resource management server, coupled to the client, the resource management server managing the first and second sets of multi-media content within the first chapter;
a resource server, coupled to the client and the resource management server, the resource server comprising a plurality of repositories, the resource server storing the presentation structure and the first and second sets of multi-media content within the plurality of repositories; and
an application server, coupled to the client and the resource management server, the application server managing access to the presentation structure and the first and second sets of multi-media content.

27. The system of claim 26 wherein the client creates the plurality of chapters that is represented in the presentation structure by performing a method comprising the steps:
designating a first set of multi-media content to be inserted in a first chapter within the plurality of chapters;
converting the first set of multi-media content to a second set of multi-media content, the second set of multi-media content being in a common data format;
storing the second set of multi-media content in a first repository;
associating a first multi-media content with a second multi-media content within the first chapter, the first and second multi-media contents being within the second set of multi-media content, such that an execution of the second multi-media content is temporally related to the execution of the first multi-media content;
defining a temporal position of the first chapter within the plurality of chapters; and
creating the presentation structure that defines a relationship of the first chapter within the plurality of chapters.

28. The system of claim 27 wherein the resource management server converts the multi-media content data to the common data format.

29. The system of claim 27 wherein the client converts the multi-media content data to the common data format.

30. The system of claim 27 wherein the first repository is within the plurality of repositories on the resource server.

31. The system of claim 27 wherein the presentation structure is stored in a second repository within the plurality of repositories on the resource server.

32. The system of claim 31 wherein the presentation structure is stored on the application server.

33. A system for viewing an online presentation, the system comprising:
a client that provides a presentation player that interprets a presentation structure defining temporal relationships between a plurality of chapters within the online presentation by rendering the plurality of chapters within the online presentation according to a rendering sequence defined by the presentation structure;
an application server, coupled to the client, the application server managing access to an online data source; and
a content delivery server, coupled to the application server and the client, the content delivery server providing a set of multi-media content data associated with the plurality of chapters to the client.

34. The system of claim 33 wherein the application server provides the client access to the presentation structure.

35. The system of claim 33 wherein the application server provides the client access to the presentation player.

36. The system of claim 33 wherein a first chapter within the plurality of chapters comprises a set of multi-media content references associated with a set of storage locations of a set of multi-media content, and rendering a first multi-media content within the set of multi-media content is performed by a method comprising the steps:
responsive to a reference within the set of multi-media content references being associated with the first multi-media content, the reference designating a second storage location within a second repository, rendering the first multi-media content by:
downloading the first multi-media content from the second repository; and
rendering the first multi-media content by the presentation player.

37. The system of claim 36 wherein the first multi-media content is downloaded from the content delivery server.
